(19) United States
(12) Patent Application Publication
(10) Pub. No.: US 2018/0077745 A1
(43) Pub. Date: Mar. 15, 2018

(54) METHOD FOR COORDINATING TERMINAL-TO-TERMINAL COMMUNICATION VIA AD-HOC NETWORK AND MOBILE COMMUNICATION NETWORK, AND MANAGEMENT SERVER DEVICE IN WHICH SAID METHOD IS IMPLEMENTED

(71) Applicant: NEC Corporation, Tokyo (JP)

(72) Inventors: Eiji HASE, Tokyo (JP); Shinji DOIWAKI, Tokyo (JP)

(73) Assignee: NEC Corporation, Minato-ku, Tokyo (JP)

(21) Appl. No.: 15/564,480

(22) PCT Filed: Apr. 13, 2016
(86) PCT No.: PCT/JP2016/061927

§ 371 Date: Oct. 5, 2017

(30) Foreign Application Priority Data
Apr. 15, 2015 (JP) 2015-083122

(51) Int. Cl. H04W 76/02

(52) U.S. Cl. CPC H04W 76/023; H04W 84/18

(57) ABSTRACT

A management server device disposed at a boundary between an ad-hoc network and a mobile communication network (3G/LTE network) and being provided with a dummy terminal for relaying communication between a first terminal device for directly communicating with other devices belonging to the ad-hoc network and a second terminal device for communicating with a base station connected to the mobile communication network. It is thereby possible to make the mobile communication network and the ad-hoc network seamlessly work in concert while suppressing effects imposed on the mobile communication network.

### TECHNICAL FIELD

The present invention relates to a method for coordinating terminal-to-terminal communication between a mobile communication network in accordance with 3G/LTE communication standards and an ad-hoc network, and a management server device in which the terminal-to-terminal communication coordinating method is implemented. This application is based upon and claims the benefit of priority from Japanese patent application No. 2015-083122, filed on Apr. 15, 2015, the disclosure of which is incorporated herein in its entirety by reference.

### BACKGROUND ART

Conventionally, there are known mobile communication in accordance with 3G/LTE communication standards, and ad-hoc communication such that direct communication is performed between wireless LANs installed in terminals. Unlike communication using a 3G/LTE network (core network), in ad-hoc communication, direct communication is performed between terminals without mediating a base station. In mobile communication using a core network, when communication is performed between terminals, the communication is performed through the core network of a communication carrier after mediating a base station once. For example, when communication is performed from a terminal device a to a terminal device b, the terminal device a performs communication with a base station c to which the terminal device a belongs, and the base station c transfers the communication to a core network. The core network specifies a base station d to which the terminal device b as a counterpart terminal belongs, and performs communication with the base station d, and then communication is performed from the base station d to the terminal device b, whereby communication is enabled between the terminal device a and the terminal device b. Herein, communication in the core network does not depend on a physical distance between the terminal device a and the terminal device b. Even when the terminal device a and the terminal device b exist at adjacent positions, it is necessary to go through a base station and the core network once when communication is performed between the terminal device a and the terminal device b.

In ad-hoc communication, a base station and a core network are not mediated. Therefore, direct communication is performed between terminal devices which exist within a distance where direct communication is enabled. On the other hand, when two terminal devices do not exist within a distance where direct communication is enabled, communication is performed by mediating another terminal device which exists within a distance where communication is enabled. For example, when communication is performed between a terminal device a and a terminal device b which do not exist within a distance where direct communication is enabled, communication is performed by mediating a terminal device c which exists between the terminal devices a and b. Although the terminal device c has no direct relation to communication between the terminal devices a and b, the terminal device c is operated in such a manner as to mediate the communication between the terminal devices a and b.

PTL 1 discloses a terminal communication path control method. According to the method, in a condition when communication is difficult in one of different communication networks, a terminal belonging to the communication network with communication difficulty is connected to a terminal belonging to a communication network in a good communication state by a proximity communication function, and the communication network in a good communication state is selected in order to secure a smooth communication environment. PTL 2 discloses a communication system capable of switching between an infrastructure mode and an ad-hoc mode, the infrastructure mode communicating with a fixed station such as a base station and a wireless access point, and an ad-hoc mode communicating between terminals by peer-to-peer connection. For example, when a failure occurs in a fixed station e, communication is performed in an ad-hoc mode between a terminal device group f belonging to the fixed station e and a terminal device h belonging to another fixed station g, whereby the terminal device group f is capable of performing communication with the fixed station g by bypassing a communication path. PTL 3 discloses a network system management method for managing coordination between network domains, or a virtual network spanning network domains. PTL 4 discloses an ad-hoc peer-to-peer mobile wireless access system.

### CITATION LIST

### Patent Literature

[PTL 1] Japanese Laid-open Patent Publication No. 2014-138248

[PTL 2] Japanese Laid-open Patent Publication No. 2014-161004

[PTL 3] Japanese Laid-open Patent Publication No. 2013-102338

[PTL 4] Japanese Laid-open Patent Publication No. 2004-526341

### SUMMARY OF INVENTION

### Technical Problem

In the communication systems of PTL 1 and PTL 2, as far as there exists a terminal device connected to a 3G/LTE network and capable of performing ad-hoc communication, it is possible to perform communication between a terminal which performs ad-hoc communication via the aforementioned terminal device, and a terminal device belonging to the 3G/LTE network. However, when the aforementioned terminal device does not exist, it is difficult to perform communication between a terminal device which performs ad-hoc communication and a terminal device belonging to the 3G/LTE network. Further, in order to perform communication in a 3G/LTE network, a terminal device is required to register position information thereof in a subscriber server such as an HLR (Home Location Register) and an HSS (Home Subscriber Server). It is not practical to register an ad-hoc communication terminal device with a subscriber server in order to perform communication using a core network.

In order to solve the aforementioned problems, an object of the present invention is to provide a method for coordinating terminal-to-terminal communication between an ad-hoc network and a mobile communication network, and a management server device in which the terminal-to-terminal communication coordinating method is implemented.

### Solution to Problem

According to the first aspect of the present invention, a management server device disposed at a boundary between an ad-hoc network and a mobile communication network, the management server device comprises:

a dummy terminal unit which relays communication between a first terminal device which performs direct communication with another device belonging to the ad-hoc network, and a second terminal device which performs communication with a base station connected to the mobile communication network.

According to the second aspect of the present invention, a communication system comprises:

a first terminal device which performs direct communication by being connected to another device belonging to an ad-hoc network;

a second terminal device which performs communication with a base station connected to a mobile communication network; and

the management server device according to the first aspect of the present invention.

According to the third aspect of the present invention, a terminal-to-terminal communication coordinating method to be applied to a communication system, the terminal-to-terminal communication coordinating method comprises:

requesting, by the first terminal device, the management server device for communication with the second terminal device, when the first terminal device performs communication with the second terminal device;

performing, by the dummy terminal unit of the management server device, communication with the second terminal device via the base station associated with position information of the second terminal device;

requesting, by the second terminal device, the dummy terminal unit for communication with the first terminal device, when the second terminal device performs communication with the first terminal device; and performing, by the dummy terminal unit of the management server device, communication with the first terminal device, based on position information of the first terminal device.

### Advantageous Effects of Invention

According to the present invention, it is possible to seamlessly relay communication between a first terminal device belonging to an ad-hoc network, and a second terminal device to be connected to a mobile communication network by disposing a management server device including a dummy terminal unit at a boundary between the ad-hoc network and the mobile communication network. In this case, it is possible to coordinate the mobile communication network and the ad-hoc network while suppressing an influence on the mobile communication network.

### BRIEF DESCRIPTION OF DRAWINGS

FIG. 1 is a block diagram illustrating a minimum configuration of a management server device according to the present invention.

FIG. 2 is a configuration diagram illustrating one example of a communication system to which the management server device according to the present invention is applied.

FIG. 3 is a block diagram illustrating a specific configuration of a management server device according to a first example embodiment of the present invention.

FIG. 4 is a flowchart illustrating a position information updating process of the management server device according to the first example embodiment of the present invention.

FIG. 5 is a sequence diagram for describing a first terminal-to-terminal communication coordinating process in a communication system to which the management server device according to the first example embodiment of the present invention is applied.

FIG. 6 is a sequence diagram for describing a second terminal-to-terminal communication coordinating process in a communication system to which the management server device according to the first example embodiment of the present invention is applied.

FIG. 7 is a block diagram illustrating a specific configuration of a management server device according to a second example embodiment of the present invention.

FIG. 8 is a block diagram for describing an operation of a virtual machine of the management server device according to the second example embodiment of the present invention.

FIG. 9 is a flowchart illustrating a process of controlling the number of running virtual machines by the management server device according to the second example embodiment of the present invention.

### DESCRIPTION OF EMBODIMENTS

A method for coordinating terminal-to-terminal communication between an ad-hoc network and a mobile communication network, and a management server device in which the terminal-to-terminal communication coordinating method is implemented, according to the present invention, are described in detail along with examples with reference to the accompanying drawings.

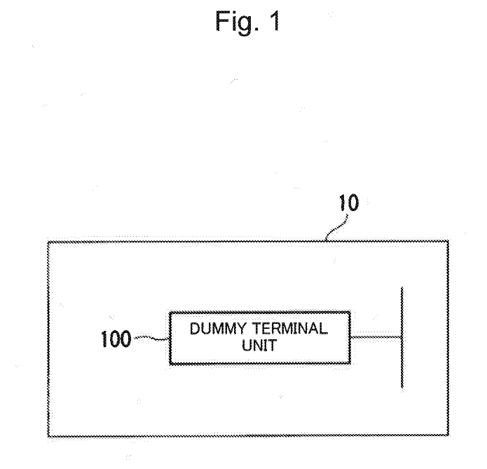

FIG. 1 is a block diagram illustrating a minimum configuration of a management server device 10 according to the present invention. The management server device 10 includes at least a dummy terminal unit 100. The dummy terminal unit 100 has a function of a mobile terminal such as a smartphone. A mobile terminal function is, for example, a function such that communication with another mobile terminal is performed via a base station connected to a mobile communication network, or a function such that direct communication (ad-hoc communication) is performed by connecting to another terminal device without mediating a base station. The dummy terminal unit 100 is capable of relaying communication between a first terminal device capable of performing ad-hoc communication, and a second terminal device which performs communication with a base station connected to a mobile communication network with use of a mobile terminal function.

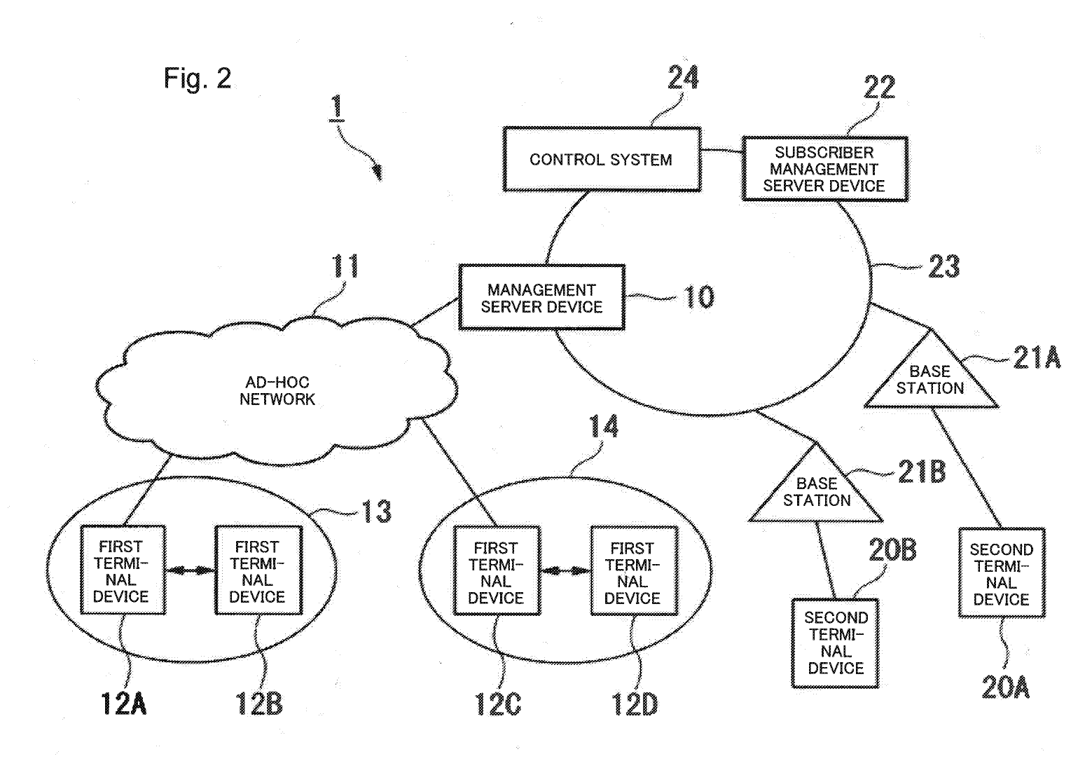

FIG. 2 is a configuration diagram illustrating one example of a communication system 1 to which the management server device 10 according to the present invention is applied. The communication system 1 is constituted by the management server 10, an ad-hoc network 11, first terminal devices 12A, 12B, 12C, and 12D, second terminal devices 20A and 20B, base stations 21A and 21B, a subscriber management server device 22, a core network 23, and a control system 24. The first terminal devices 12A to 12D are generically referred to as first terminal devices 12. The second terminal devices 20A and 20B are generically referred to as second terminal devices 20. The base stations 21A and 21B are generically referred to as base stations 21.

The management server device 10 is disposed at a boundary between the ad-hoc network 11 and the core network 23. In other words, the management server device 10 is connected to be communicable with the ad-hoc network 11 and the core network 23.

The ad-hoc network 11 is formed by ad-hoc communication among the first terminal devices 12A to 12D. Note that the ad-hoc network 11 may include the Internet. Ad-hoc communication includes communication via another terminal device when communication is performed between two terminal devices. However, when only terminal-to-terminal communication is performed, only communication with a terminal device located at a short distance is enabled due to the limit of the number of terminals via which communication is performed. Therefore, practicability is low. In view of the above, the communication system 1 is configured such that communication is performed with terminal devices all over Japan by using the Internet included in the ad-hoc network 11. First of all, a group of terminal devices located within a short distance and capable of performing ad-hoc communication without using the Internet is defined as an ad-hoc group. In the communication system 1 illustrated in FIG. 2, the first terminal devices 12A and 12B form an ad-hoc group 13, and the first terminal devices 12C and 12D form an ad-hoc group 14. The first terminal devices 12 within the same ad-hoc group are capable of performing direct communication with each other, and communication is enabled via another one of the first terminal devices 12 within the same ad-hoc group.

Further, in an ad-hoc group, there exists one terminal device to be connected to the Internet. Hereinafter, a terminal to be connected to the Internet is referred to as a representative terminal. A representative terminal means, for example, a terminal device which exists at a position nearest to an access point for the Internet connection. A representative terminal, however, is not limited to the above. In the communication system 1, the first terminal device 12A is designated as a representative terminal in the ad-hoc group 13, and the first terminal device 12C is designated as a representative terminal in the ad-hoc group 14. The management server device 10 stores terminal information of the first terminal devices 12 belonging to the ad-hoc groups 13 and 14, and mediates ad-hoc communication between the ad-hoc groups 13 and 14. A representative terminal transmits, to the management server device 10, identification information of the first terminal devices 12 which exist within an ad-hoc group to which the representative terminal belongs when an ad-hoc network is formed. In other words, the first terminal device 12A transmits, to the management server device 10, identification information of the first terminal devices 12A and 12B belonging to the ad-hoc group 13; and the first terminal device 12C transmits, to the management server device 10, identification information of the first terminal devices 12C and 12D belonging to the ad-hoc group 14. The management server device 10 stores to which ad-hoc group, each one of the first terminal devices belongs. When performing ad-hoc communication, a representative terminal requests the management server device 10 for which ad-hoc group, the first terminal device 12 as a counterpart terminal belongs, whereby communication with the counterpart first terminal device 12 is enabled. In this way, including the Internet in the ad-hoc network 11 makes it possible to perform ad-hoc communication between the first terminal devices 12 located at a long distance.

The core network 23 is a core network of a mobile communication network under 3G/LTE communication standards. The second terminal devices 20A and 20B perform mobile communication with use of the base stations 21A and 21B and the core network 23. In other words, the second terminal device 20A performs communication via the base station 21A and the core network 23, and the second terminal device 20B performs communication via the base station 21B and the core network 23. For example, when communication is performed from the second terminal device 20A to the second terminal device 20B, first of all, the second terminal device 20A starts communication with the base station 21A. The base station 21A transmits a communication request from the second terminal device 20A to the control system 24 which preforms communication connection control using the core network 23. The control system 24 acquires information on a communication destination included in a communication request from the second terminal device 20A (in other words, information relating to the second terminal device 20B), and requests the subscriber management server device 22 for position information of the second terminal device 20B. The subscriber management server device 22 provides the control system 24 with position information of the second terminal device 20B. Position information is, for example, information acquired from the base station 21 by the second terminal device 20. The base station 21 periodically outputs information indicating an area to be managed by the base station 21. The second terminal device 20 transmits, to the subscriber management server device 22, area information received from the base station 21 to which the second terminal device 20 belongs, as position information of the second terminal device 20. This allows for the subscriber management server device 22 to grasp to which base station 21, the target second terminal device 20 currently belongs. The subscriber management server device 22 is disposed within the core network 23. The subscriber management server device 22 manages identification information of the second terminal device 20 using the core network 23, information of communication services under contract (contract information), and authentication information to be used for user authentication, in addition to position information.

The control system 24 specifies the base station 21B associated with position information of the second terminal device 20B, and controls the base station 21B to communicate with the second terminal 20B. In this way, the second terminal devices 20A and 20B perform communication via the base station 21A, the core network 23, and the base station 21B. Note that, when the second terminal device 20A is activated or moved, position information of the second terminal device 20A stored in the subscriber management server 22 is updated. The same configuration as described above is also applied to the second terminal device 20B.

In a general communication system, it is not possible to perform communication between the first terminal device 12 and the second terminal device 20. In order to perform communication between the first terminal device 12 and the second terminal device 20, it is necessary, for example, to register identification information, contract information, and authentication information of the first terminal device 12 in the subscriber management server device 22. These pieces of information to be registered in the subscriber management server device 22 are recorded in an SIM card, for example, and the SIM card is mounted in the second terminal device 20. In order to prepare an SIM card in such a manner that communication is enabled between the first terminal device 12 and the second terminal device 20, modification of hardware resources is necessary. This is not practical. Further, it is necessary to perform an operation of registering information of the first terminal device 12 in the subscriber management server device 22. However, the first terminal device 12 becomes temporarily unusable during the registering operation.

In view of the above, in the present invention, an ad-hoc communication function is provided to the management server device 10 which is communicable with the core network 23 and the ad-hoc network 11, and the dummy terminal unit 100 having a mobile terminal function capable of performing communication using the core network 23 is caused to run so as to allow the dummy terminal unit 100 to relay communication between the first terminal device 12 and the second terminal device 20.

### First Example Embodiment

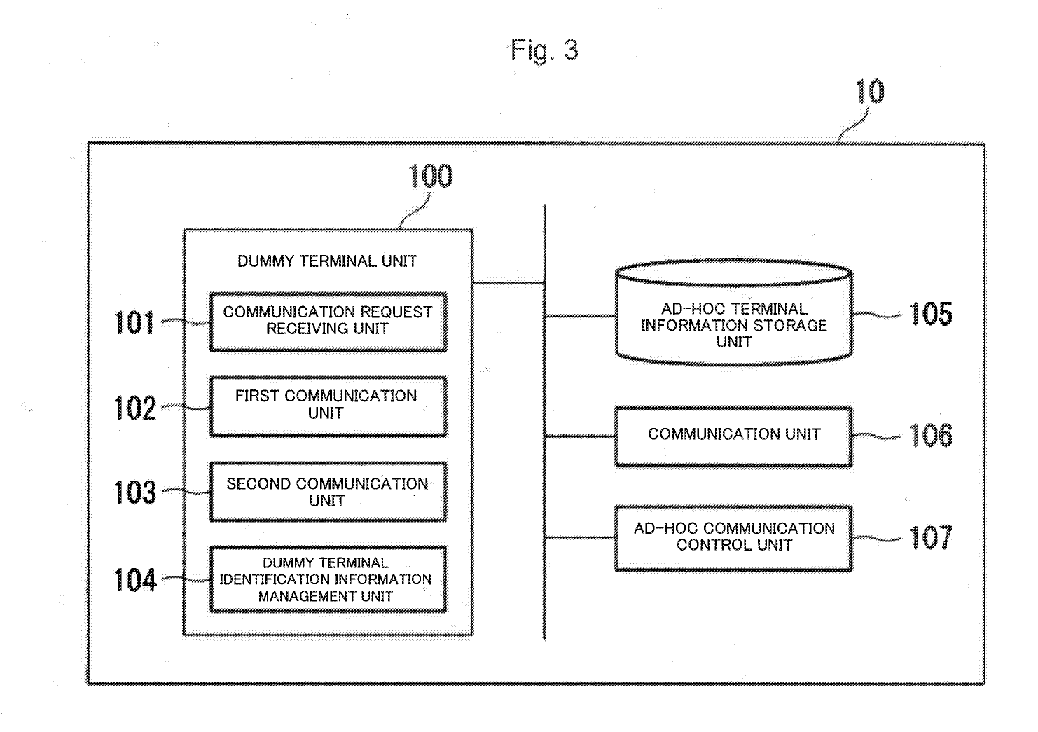

FIG. 3 is a block diagram illustrating a specific configuration of a management server device 10 according to the first example embodiment of the present invention. The management server device 10 illustrated in FIG. 3 includes a dummy terminal unit 100, an ad-hoc terminal information storage unit 105, a communication unit 106, and an ad-hoc communication control unit 107. The dummy terminal unit 100 includes a communication request receiving unit 101, a first communication unit 102, a second communication unit 103, and a dummy terminal identification information management unit 104.

The communication request receiving unit 101 detects the presence or absence of communication from a first terminal device 12 or a second terminal device 20, and receives a communication request. The first communication unit 102 performs ad-hoc communication by a communication method such as a Wi-Fi method (wireless LAN method) or Bluetooth (registered trademark). The second communication unit 103 performs communication via a core network 23 and a base station 21 by a 3G/LTE communication method. The dummy terminal identification information management unit 104 stores identification information, contract information, authentication information, and the like of the dummy terminal unit 100, and transmits these pieces of information and current position information of the dummy terminal unit 100 to a subscriber management server device 22 when the dummy terminal unit 100 is activated. The dummy terminal unit 100 virtually implements a function of the second terminal device 20 and an ad-hoc communication function by the aforementioned functional units 101 to 104.

The ad-hoc terminal information storage unit 105 stores information of the first terminal device 12 belonging to an ad-hoc group for each ad-hoc group in coordination with the core network 23. For example, the ad-hoc terminal information storage unit 105 stores identification information, and communication information such as an IP address of a representative terminal (a first terminal 12A) of an ad-hoc group 13. Further, the ad-hoc terminal information storage unit 105 stores identification information of another terminal (a first terminal 12B) belonging to the ad-hoc group 13. The same configuration as described above is also applied to an ad-hoc group 14.

The communication unit 106 is a communication device including an antenna, a communication interface, and the like which perform communication between a terminal device to be connected to an ad-hoc network 11, and a terminal device which performs communication using the core network 23. The functional units 101 to 104 of the dummy terminal unit 100 perform communication with another terminal device via the communication unit 106. The ad-hoc communication control unit 107 controls ad-hoc communication between the first terminal devices 12 belonging to the ad-hoc network 11.

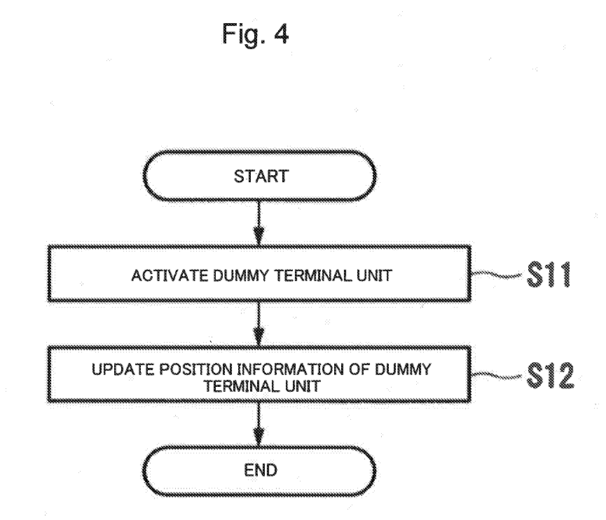

FIG. 4 is a flowchart illustrating a position information updating process of the management server device 10 according to the first example embodiment of the present invention. A process of registering position information of the dummy terminal unit 100 in the subscriber management server device 22 by the management server device 10 is described using the flowchart of FIG. 4. Note that the dummy terminal unit 100 is configured to be automatically activated when the management server device 10 is activated. Further, it is assumed that identification information, contract information, and the like of the dummy terminal unit 100 are registered in advance in the subscriber management server device 22.

First of all, when power supply of the management server device 10 is turned on, the dummy terminal unit 100 is also automatically activated (Step S11). When the dummy terminal unit 100 is activated, the dummy terminal identification information management unit 104 communicates with a base station 21 nearby, and acquires position information of the dummy terminal unit 100. The dummy terminal identification information management unit 104 transmits position information of the dummy terminal unit 100 to the subscriber management server device 22 via the communication unit 106. The subscriber management server device 22 updates position information of the dummy terminal unit 100 (Step S12). This enables communication between the dummy terminal unit 100 and the second terminal device 20 using the core network 23. Note that the subscriber management server device 22 is configured to provide position information of the dummy terminal unit 100 when position information of an unregistered terminal device (e.g. the first terminal device 12) is requested.

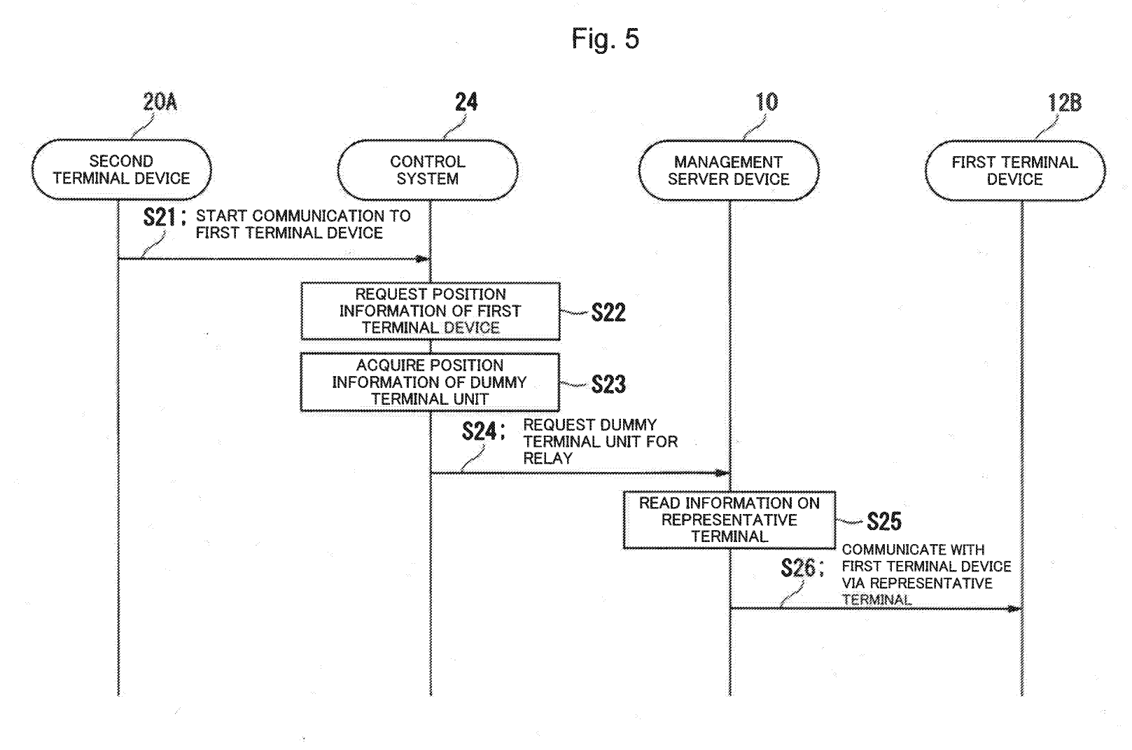

FIG. 5 is a sequence diagram for describing a first terminal-to-terminal communication coordinating process in a communication system to which the management server device 10 according to the first example embodiment of the present invention is applied. With reference to FIG. 5, a case is described in which a second terminal device 20A performs communication with the first terminal device 12B via a control system 24 and the management server device 10.

First of all, the second terminal device 20A starts communication with the first terminal device 12B (Step S21). A base station 21A receives a communication request transmitted by the second terminal device 20A, and transmits the received communication request to the control system 24. The control system 24 requests the subscriber management server device 22 for position information of the first terminal device 12B (Step S22). The subscriber management server device 22 does not store information of the first terminal device 12B. Therefore, the subscriber management server device 22 provides the control system 24 with position information and communication information such as an IP address of the dummy terminal unit 100, in place of the aforementioned information. The control system 24 acquires position information of the dummy terminal unit 100 (Step S23). The control system 24 specifies a base station 21 nearby the dummy terminal unit 100 based on position information of the dummy terminal unit 100, and requests the dummy terminal unit 100 of the management server device 10 for a communication relay via the base station 21 (Step S24).

In the management server device 10, the communication unit 106 receives a request for communication relay from the control system 24, and outputs the request for communication relay to the communication request receiving unit 101 of the dummy terminal unit 100. The relay request includes, for example, information designating a communication relay from the core network 23 to the ad-hoc network 11. The communication request receiving unit 101 outputs a relay request to the first communication unit 102 based on the designation information. In this case, communication is from the core network 23 (the second terminal device 20A) to the ad-hoc network 11 (in other words, a direction toward the first terminal device 12B). Therefore, the communication request receiving unit 101 outputs a relay request acquired by the communication unit 106 to the first communication unit 102 which performs ad-hoc communication. The first communication unit 102 reads information on a communication destination included in the relay request (in other words, information on the first terminal device 12B). The first communication unit 102 searches, from the ad-hoc terminal information storage unit 105, identification information of an ad-hoc group to which the first terminal device 12B as a communication destination belongs. Next, the first communication unit 102 reads, from the ad-hoc terminal information storage unit 105, information on a representative terminal of the ad-hoc group to which the first terminal device 12B belongs (e.g. identification information and an IP address) (Step S25). For example, the first communication unit 102 reads, from the ad-hoc terminal information storage unit 105, that the first terminal device 12B belongs to the ad-hoc group 13, and the representative terminal is the first terminal device 12A.

Next, the dummy terminal unit 100 communicates with the first terminal device 12B via a representative terminal (Step S26). Specifically, the first communication unit 102 requests a representative terminal (in other words, the first terminal device 12A) for a communication relay to the first terminal device 12B. The first terminal device 12A performs communication with the first terminal device 12B by a well-known ad-hoc communication step. This allows for the second terminal device 20A belonging to the core network 23 to perform communication with the first terminal device 12B belonging to the ad-hoc network 11 via the dummy terminal unit 100.

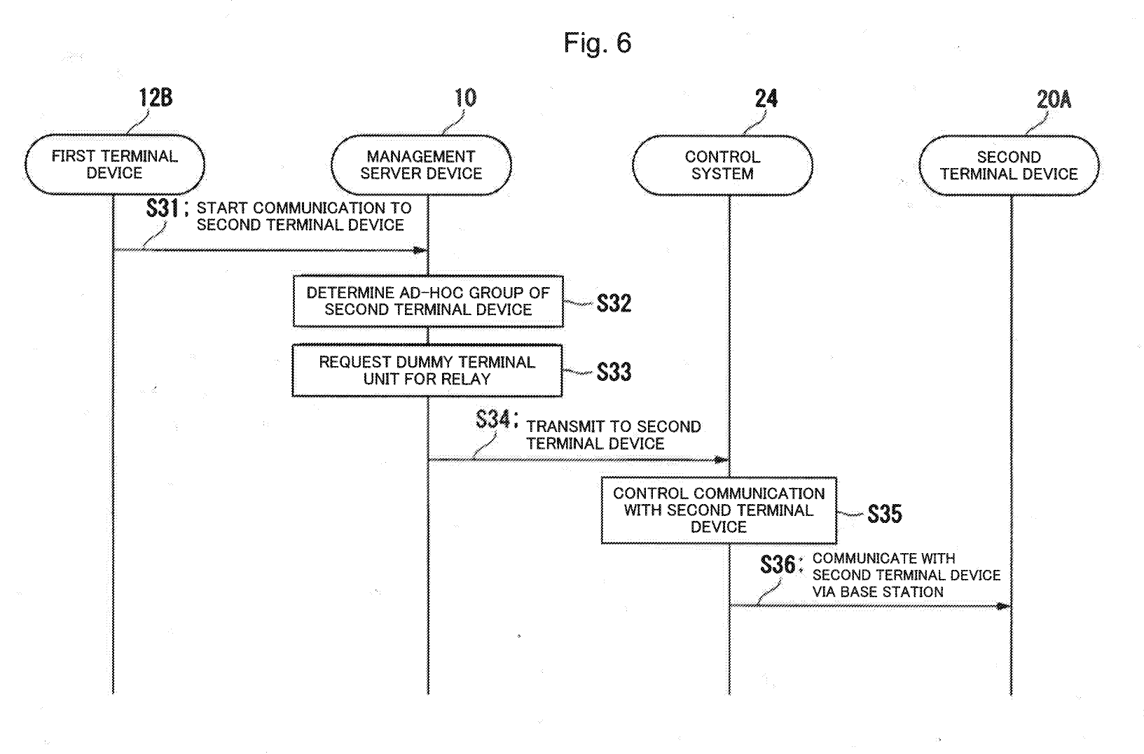

FIG. 6 is a sequence diagram for describing a second terminal-to-terminal communication coordinating process in a communication system to which the management server device 10 according to the first example embodiment of the present invention is applied. With reference to FIG. 6, a case is described, in which the first terminal device 12B performs communication with the second terminal device 20A via the control system 24 and the management server device 10.

First of all, the first terminal device 12B starts communication with the second terminal device 20A (Step S31). Specifically, the first terminal device 12B requests a representative terminal of an ad-hoc group to which the first terminal device 12B belongs (in other words, the first terminal device 12A) for communication with the second terminal device 20A. The first terminal device 12A transmits a communication request of the first terminal device 12B to the management server device 10, and requests a communication relay to the second terminal device 20A.

In the management server device 10, the communication unit 106 receives a communication request and a relay request from the first terminal device 12B, and transmits the communication request and the relay request to the ad-hoc communication control unit 107. The ad-hoc communication control unit 107 reads information on a communication destination included in the relay request (in other words, the second terminal device 20A), and searches the ad-hoc terminal information storage unit 105 to determine to which ad-hoc group the communication destination belongs (Step S32). The ad-hoc communication control unit 107 judges that the second terminal device 20A is not a terminal device belonging to the ad-hoc network 11, because information on the second terminal device 20A as a communication destination is not registered in the ad-hoc terminal information storage unit 105. The ad-hoc communication control unit 107 outputs, to the dummy terminal unit 100, a relay request, and a flag indicating that a communication destination is a terminal device belonging to the core network 23, and requests the dummy terminal unit 100 for a communication relay (Step S33). In the dummy terminal unit 100, the communication request receiving unit 101 transmits a relay request to the second communication unit 103 which performs communication using the core network 23, based on a flag indicating a communication destination. The second communication unit 103 reads information on a communication destination included in the relay request (in other words, the second terminal device 20A), and transmits communication with the second terminal device 20A (Step S34).

Next, the control system 24 controls communication with the second terminal device 20A (Step S35). Specifically, the control system 24 receives communication relayed by the dummy terminal unit 100 via a base station 21 nearby the dummy terminal unit 100. The control system 24 requests the subscriber management server device 22 for position information of the second terminal device 20A. The subscriber management server device 22 provides the control system 24 with position information of the second terminal device 20A. The control system 24 acquires position information of the second terminal device 20A, and specifies the base station 21A to which the second terminal device 20A belongs. Next, the control system 24 performs communication with the second terminal device 20A via the base station 21A (Step S36). This allows for the first terminal device 12B belonging to the ad-hoc network 11 to perform communication with the second terminal device 20A connected to the core network 23 via the dummy terminal unit 100.

In the present example, a dummy terminal (the dummy terminal unit 100) is disposed at a boundary between the core network 23 and the ad-hoc network 11. The second terminal device 20 connected to the core network 23 is allowed to communicate with the first terminal device 12 belonging to the ad-hoc network 11 by mediating the dummy terminal unit 100. Further, the first terminal unit 12 belonging to the ad-hoc network 11 is allowed to communicate with the second terminal device 20 connected to the core network 23 by mediating the dummy terminal unit 100. Further, according to the present example, the management server device 10 is disposed at a position where the management server device 10 is communicable with the core network 23 and the ad-hoc network 11. Therefore, it is possible to coordinate between the core network 23 and the ad-hoc network 11 while suppressing an influence on the core network 23.

### Second Example Embodiment

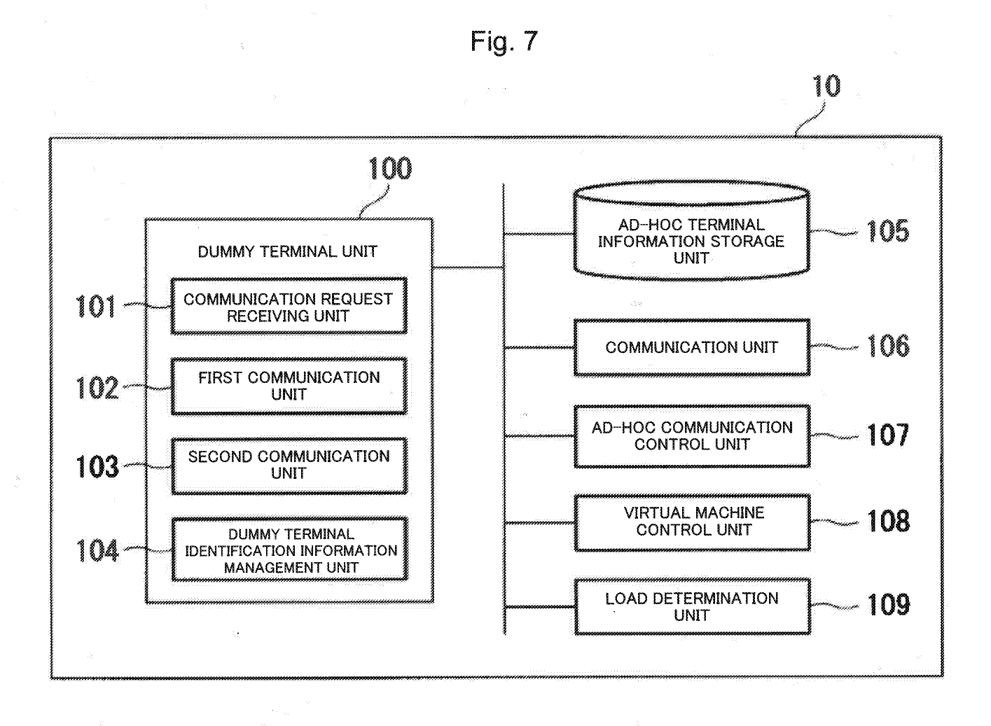

Next, a management server device 10 according to the second example embodiment of the present invention is described in detail with reference to FIG. 7 to FIG. 9. FIG. 7 is a block diagram illustrating a specific configuration of the management server device 10 according to the second example embodiment of the present invention. In FIG. 7, same constituent elements as the constituent elements illustrated in FIG. 3 are indicated by the same reference numerals. The management server device 10 according to the second example embodiment is different from the management server device 10 according to the first example embodiment in a point that a virtual machine control unit 108 and a load determination unit 109 are included. Further, the management server device 10 according to the second example embodiment includes an execution environment of a virtual machine. A virtual machine is an element, by which an operation of a platform, such as an OS (Operating System) or a communication function, on which the management server device 10 can run a dummy terminal unit 100, is emulated. A virtual machine is implemented by causing a CPU (Central Processing Unit) provided in the management server device 10 to execute a software which emulates a function as a server device, such as an OS or a communication function. The management server device 10 according to the second example embodiment includes same constituent elements 101 to 107 as those of the management server device 10 according to the first example embodiment, and detailed description of the constituent elements 101 to 107 is omitted.

The virtual machine control unit 108 controls activation and deactivation of a virtual machine which provides a platform on which the dummy terminal unit 100 runs. A function of the dummy terminal unit 100 is mounted in a virtual machine to be controlled by the virtual machine control unit 108. The load determination unit 109 determines a load state of a virtual machine.

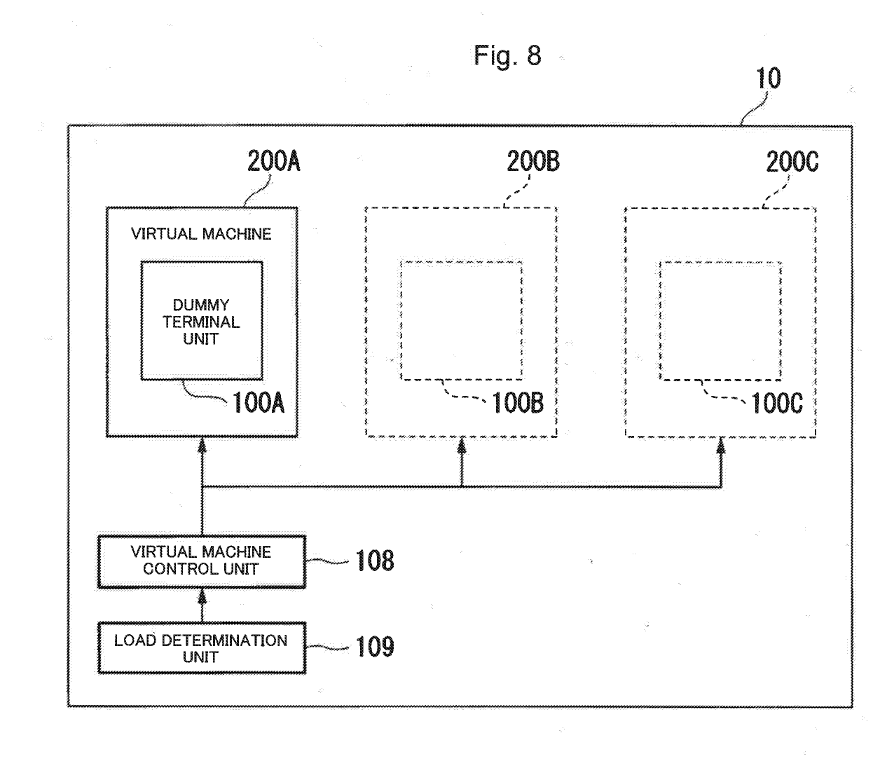

FIG. 8 is a block diagram for describing an operation of a virtual machine of a management server device according to the second example embodiment of the present invention. As illustrated in FIG. 8, a management server device 10 includes virtual machines 200A, 200B, and 200C. Note that the virtual machines 200A to 200C are generically referred to as virtual machines 200. Activation and deactivation of the virtual machines 200 are controlled by the virtual machine control unit 108. It is configured such that when a virtual machine 200 is activated, the dummy terminal unit 100 is automatically started up. Specifically, a dummy terminal unit 100A runs on the virtual machine 200A. Likewise, a dummy terminal unit 100B runs on the virtual machine 200B, and a dummy terminal unit 100C runs on the virtual machine 200C. The virtual machine control unit 108 decides the number of virtual machines to run depending on a load state of currently running virtual machines 200. The load state of currently running virtual machines 200 is determined by the load determination unit 109.

For example, it is assumed that when the management server device 10 is activated, the virtual machine 200A is activated. Further, it is assumed that when the virtual machine 200A is activated, the dummy terminal unit 100A is activated. The load determination unit 109 monitors a load state (such as a CPU utilization rate) of the virtual machine 200A on which the dummy terminal unit 100A runs. When communication between a first terminal device 12 and a second terminal device 20 increases, and a process of the dummy terminal unit 100A increases, a load of the virtual machine 200A increases. Then, the load determination unit 109 determines that the load of the virtual machine 200A is high. The virtual machine control unit 108 activates the virtual machine 200B based on the determination result of the load determination unit 109, and adds one virtual machine 200. Further, when a communication amount increases, and the load of the virtual machines 200A and 200B increases, the virtual machine control unit 108 activates the virtual machine 200C, and further adds a virtual machine 200.

Further, when communication between the first terminal device 12 and the second terminal device 20 decreases, and the load of the virtual machines 200A, 200B, and 200C decreases, the load determination unit 109 determines that the load of the virtual machines 200A, 200B, and 200C is light. The virtual machine control unit 108 deactivates the virtual machine 200C based on the determination result of the load determination unit 109. Further, when the load of the virtual machines 200A and 200B decreases, the virtual machine control unit 108 deactivates the virtual machine 200B.

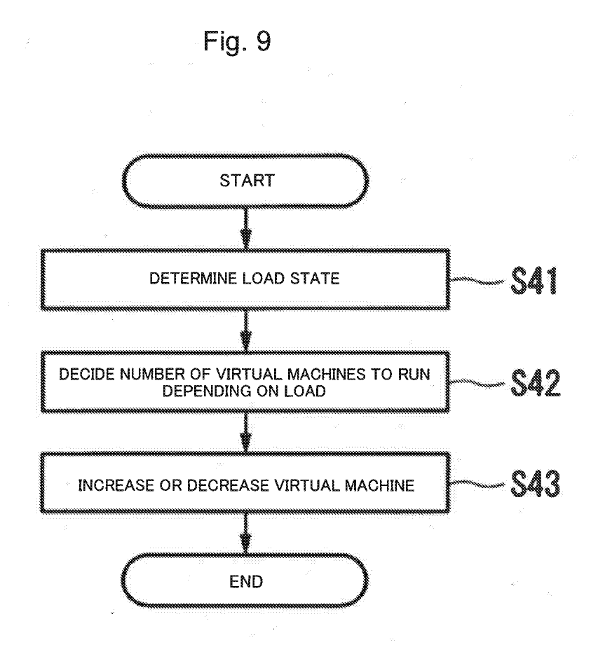

FIG. 9 is a flowchart illustrating a process of controlling the number of virtual machines 200 to run by the management server device 10 according to the second example embodiment of the present invention. Referring to the flowchart illustrated in FIG. 9, a process of controlling the number of virtual machines 200 to run by the management server device 10 is described. First of all, it is assumed that the virtual machine 200A is running. The load determination unit 109 determines a load state of the virtual machine 200A at a predetermined time interval (Step S41). The load determination unit 109 compares between a load state amount of the virtual machine 200A and a predetermined threshold value for each monitoring item specified for determining a load state. Monitoring items are, for example, a CPU utilization rate of the virtual machine 200A, a data transfer rate of a network interface, and the like. When one of the monitoring items exceeds a threshold value, the load determination unit 109 determines that the load of the virtual machine 200A is high. When values of all the monitoring items are equal to or lower than threshold values, the load determination unit 109 determines that the load of the virtual machine 200A is low. When a plurality of virtual machines 200 are running, the load determination unit 109 determines a load state for each of the virtual machines 200. The load determination unit 109 outputs a determination result on a load state of each virtual machine 200 to the virtual machine control unit 108.

Next, the virtual machine control unit 108 decides the number of virtual machines 200 to run depending on a load, based on the determination result on a load state of each virtual machine 200 (Step S42). For example, when the load of the virtual machine 200A is high in a state that the virtual machine 200A is running, the virtual machine control unit 108 decides to increase the number of virtual machines 200 to run by one. On the other hand, when the load of the three virtual machines 200A to 200C is low in a state that the three virtual machines 200A to 200C are running, the virtual machine control unit 108 decides to decrease the number of virtual machines 200 to run by one.

Next, the virtual machine control unit 108 increases or decreases a virtual machine 200 so that the number of virtual machines 200 to run is equal to the decided number (Step S43). For example, when one virtual machine 200 is added from a state that the virtual machine 200A is running, the virtual machine control unit 108 activates the virtual machine 200B. On the other hand, when one virtual machine 200 is decreased from a state that the virtual machines 200A to 200C are running, the virtual machine control unit 108 deactivates the virtual machine 200C.

In addition to the advantageous effects of the first example embodiment, the second example embodiment provides advantageous effects such that it is possible to promptly handle an increase of a communication amount by increasing the number of virtual machines 200 to run even when a communication amount between the first terminal device 12 belonging to an ad-hoc network 11, and the second terminal device 20 connected to a core network 23 increases. Further, when resources of the management server device 10 are sufficient, it is possible to advantageously use the resources.

The aforementioned management server device 10 internally includes a computer system. Further, a processing step of the management server device 10 is stored in a computer readable recording medium in the form of a program, and the aforementioned processing step is implemented by causing the computer system to read and execute the program. Herein, a computer readable recording medium is a magnetic disk, a magneto-optical disk, a CD-ROM, a DVD-ROM, a semiconductor memory, and the like. Further, a program may be distributed to a computer by a communication line, and the computer may execute the program.

The aforementioned program may be a program for use in implementing a part of the aforementioned functions. Further, the aforementioned program may be a so-called difference file (difference program) such that the aforementioned functions can be implemented by combination with a program which is already recorded in the computer system.

Lastly, the present invention is not limited to the aforementioned examples, but may include design changes and modifications within the scope of the invention defined within the scope of the appended claims without departing from the gist of the invention.

### INDUSTRIAL APPLICABILITY

The present invention relates to a management server device in which a method for coordinating terminal-to-terminal communication between an ad-hoc network and a mobile communication network such as a 3G/LTE network is implemented. The present invention, however, is not limited to the above. In other words, the present invention is also applicable to a method for coordinating communication between terminal devices belonging to a communication network, in which a different communication standard or a different transmission protocol is implemented.

### REFERENCE SIGNS LIST

1 Communication system
10 Management server device
11 Ad-hoc network
12, 12A, 12B, 12C, 12D First terminal device
13, 14 Ad-hoc group
20, 20A, 20B Second terminal device
21, 21A, 21B Base station
22 Subscriber management server device
23 Core network
100 Dummy terminal unit
101 Communication request receiving unit
102 First communication unit
103 Second communication unit
104 Dummy terminal identification information management unit
105 Ad-hoc terminal information storage unit
106 Communication unit
107 Ad-hoc communication control unit
108 Virtual machine control unit
109 Load determination unit
200 Virtual machine

What is claimed is:

1. A management server device disposed at a boundary between an ad-hoc network and a mobile communication network, the management server device comprising:
a dummy terminal unit which relays communication between a first terminal device which performs direct communication with another device belonging to the ad-hoc network, and a second terminal device which performs communication with a base station connected to the mobile communication network.

2. The management server device according to claim 1, wherein
the dummy terminal unit comprises
a first communication unit which performs direct communication by being connected to another device belonging to the ad-hoc network, and
a second communication unit which performs communication with a base station connected to the mobile communication network, and
the dummy terminal unit performs communication with the first terminal device via the first communication unit, and performs communication with the second terminal device via the second communication unit.

3. The management server device according to claim 1, further comprising:
a virtual machine control unit which controls activation and deactivation of a virtual machine which provides a platform on which the dummy terminal unit runs.

4. The management server device according to claim 3, further comprising:
a load determination unit which determines a load state of the virtual machine, wherein
the virtual machine control unit determines a number of the virtual machines to run depending on a determination result of the load determination unit.

5. A communication system comprising:
a first terminal device which performs direct communication by being connected to another device belonging to an ad-hoc network;
a second terminal device which performs communication with a base station connected to a mobile communication network; and
the management server device according to claim 1.

6. The communication system according to claim 5, further comprising:
a subscriber management server device which stores position information of the second terminal device connected to the mobile communication network, wherein
the subscriber management server device registers position information of the dummy terminal unit when the dummy terminal unit of the management server device is activated.

7. The communication system according to claim 6, wherein,
in response to receiving a request for position information of a terminal device other than the second terminal device stored in the subscriber management server device, the subscriber management server device provides position information of the dummy terminal unit of the management server device.

8. The communication system according to claim 6, wherein,
when the first terminal device performs communication with the second terminal device, the first terminal device requests the management server device for communication with the second terminal device, and
the dummy terminal unit of the management server device performs communication with the second terminal device via the base station associated with position information of the second terminal device stored in the subscriber management server device.

9. The communication system according to claim 8, wherein
the management server device further comprises an ad-hoc terminal information storage unit which stores position information of the first terminal device,
when the second terminal device performs communication with the first terminal device, the second terminal device requests the dummy terminal unit for communication with the first terminal device by referring to position information stored in the subscriber management server device, and
the dummy terminal unit of the management server device performs communication with the first terminal device by referring to position information stored in the ad-hoc terminal information storage unit.

10. A terminal-to-terminal communication coordinating method to be applied to a communication system comprising:
a first terminal device which performs direct communication by being connected to another device belonging to an ad-hoc network;
a second terminal device which performs communication with a base station connected to a mobile communication network; and
a management server device comprising a dummy terminal unit disposed at a boundary between the ad-hoc network and the mobile communication network, and configured to relay communication between the first terminal device and the second terminal device,
the terminal-to-terminal communication coordinating method comprising:
requesting, by the first terminal device, the management server device for communication with the second terminal device, when the first terminal device performs communication with the second terminal device;
performing, by the dummy terminal unit of the management server device, communication with the second terminal device via the base station associated with position information of the second terminal device;
requesting, by the second terminal device, the dummy terminal unit for communication with the first terminal device, when the second terminal device performs communication with the first terminal device; and
performing, by the dummy terminal unit of the management server device, communication with the first terminal device, based on position information of the first terminal device.
